(19) United States
(12) Patent Application Publication
(10) Pub. No.: US 2005/0160639 A1
(43) Pub. Date: Jul. 28, 2005

(54) Wire identification marker assembly and process for manufacturing

(76) Inventor: Kenneth Gray Smith JR., Gallatin, TN (US)

Correspondence Address: DORITY & MANNING, P.A., POST OFFICE BOX 1449, GREENVILLE, SC, 29602-1449, US

(21) Appl. No.: 10/763,703

(22) Filed: Jan. 23, 2004

(51) Int. Cl. G09F 3/00

(52) U.S. Cl. 40/316

(57) ABSTRACT

A wire identification marker assembly and process for manufacturing the same is provided. The wire identification marker assembly is configured from a column of markers removably attached lengthwise on a substrate. In the process for manufacturing the wire identification assembly, a marker material is removably secured lengthwise onto a substrate.

### BACKGROUND OF THE INVENTION

Wire identification markers are commonly used to identify wires, electrical terminals, cables and the like. To aid an electrician in properly installing or servicing wires, wire identification markers are installed for marking and identifying wires and circuits in electric wiring systems, cables, or in complex electrical or electronic devices.

The use of indicia bearing wire markers greatly simplifies the identification of wires. Such wire markers may be preprinted by the manufacturer or blank, wherein the end user prints the desired indicia thereon. The latter type is more versatile and economical to the end user in that the desired indicia may be printed on the marker at an on-site location. In some instances, a thermal transfer printer is utilized to print to such blank, printable wire markers.

In the past, wire markers were manufactured laterally across a web with a gap or space placed between rows of markers. The gap or space served as a print sensor for printer registration purposes of the end user. Including a gap or space between wire marker rows and applying the markers laterally requires sophisticated equipment, and slowed the manufacturing process considerably.

Accordingly, a need exists for a wire marker that requires less sophisticated equipment to manufacture. In addition, it would be desirable to speed the manufacture of wire markers. Finally, it would be desirable for the wire markers of any new process to be compatible with the existing printer equipment of an end user.

### SUMMARY OF THE INVENTION

Objects and advantages of the invention will be set forth in part in the following description, or may be obvious from the description set forth herein.

In response to the difficulties and problems encountered in the prior art, an improved wire identification marker system is disclosed. In one exemplary embodiment of the present invention, a sheet of wire identification markers is provided. The sheet of wire identification markers is made up of a substrate having a first edge and a second edge. The first edge and second edge are arranged lengthwise along the substrate. A column of markers is removably attached to the substrate and arranged lengthwise along the substrate. The column of markers is configured from a plurality of markers that are positioned lengthwise and adjacent to one another. The plurality of markers is made up of a first and last marker and a plurality of intermediate markers. Each marker has a front end and a rear end and each marker is preferably positioned such that the front end of each intermediate marker is aligned with the rear end of each adjacent marker.

In certain embodiments of the present invention, the sheet of wire identification markers may also have characteristics for printer sensing positioned along the substrate. The sheet of wire identification markers may have more than one column of markers located along the substrate. The plurality of markers may be removably attached to the substrate, preferably with an adhesive, and in an abutting relationship with each next adjacent marker.

In another exemplary embodiment of the present invention, a set of wire identification sleeves is provided. The set of wire identification sleeves is located on a substrate having a first edge and a second edge with the first edge and second edge arranged lengthwise along the substrate. A column of sleeves is removably attached to the substrate and arranged lengthwise along the substrate. The column of sleeves is configured from a plurality of sleeves that are positioned lengthwise and adjacent to one another. The plurality of sleeves is configured from a first and last sleeve and intermediate sleeves with each sleeve having a front opening and a rear opening and preferably positioned such that the front opening of each intermediate sleeve is aligned with the rear opening of each adjacent sleeve.

In still another exemplary embodiment of the present invention, a process for forming a wire identification marker system is provided. The process involves feeding a continuous length substrate along an intended path. A continuous length marker material is provided and fed along the intended path for location onto the top of the substrate. The marker material is forced against the substrate and removably secured thereto, preferably by adhesive, and most preferably an adhesive coating on the substrate. The marker material is cut to define a plurality of individual markers in columnar alignment.

In yet another exemplary embodiment, a process for forming a set of identification sleeves is provided. The process involves providing a continuous length substrate, preferably coated with adhesive, and feeding the substrate through a roll system along an intended path. A continuous length marker tubing is provided and fed through the roll system to be placed atop the substrate. Roll pressure is utilized to force the tubing against the substrate and into the adhesive coating for removable securement. The tubing is then cut into desired lengths while secured to the substrate.

Notches or other characteristics for print registration may be provided if desired at locations along the substrate, preferably at the junctions between adjacent markers. Further, the substrate may be treated to deactivate or mask exposed adhesive in instances where the substrate is coated with adhesive.

### BRIEF DESCRIPTION OF THE DRAWINGS

FIG. 1 is a perspective view of an application of markers from an exemplary embodiment of the present invention.

FIG. 2 is a perspective view of an exemplary embodiment of the present invention.

FIGS. 3 through 5 illustrate the prior art.

FIGS. 6A through 6D illustrate an exemplary embodiment of the process according to the present invention for manufacturing the wire marker system.

### DETAILED DESCRIPTION OF PREFERRED EMBODIMENTS

Reference now will be made to the embodiments of the invention, one or more examples of which are set forth below. Each example is provided by way of explanation of the invention, not as a limitation of the invention. In fact, it will be apparent to those skilled in the art that various modifications and variations can be made to this invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims. Other objects, features, and aspects of the present invention are disclosed in or are obvious from the following detailed description.

In general, the present invention is directed to a wire identification marker system. By applying markers lengthwise with respect to a substrate, it has been determined that less sophisticated equipment can be utilized to manufacture wire identification marker systems. In addition, the manufacturing process is streamlined making it more efficient.

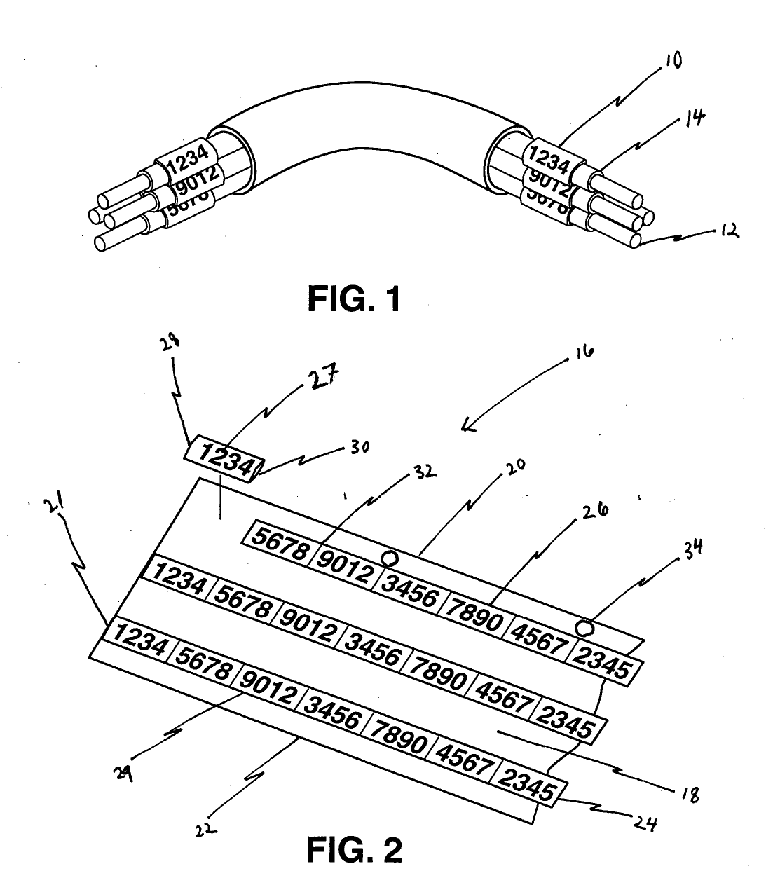

Referring to FIG. 1, a perspective view of a bundle of typical electrical wires is shown with each wire carrying a wire marker 10 at each end, as illustrated. The wire marker 10 forms a part of the present invention. Typically, electrical wire includes an inner copper electrical conductor 12 that is covered by an insulative covering 14 of plastic or rubber.

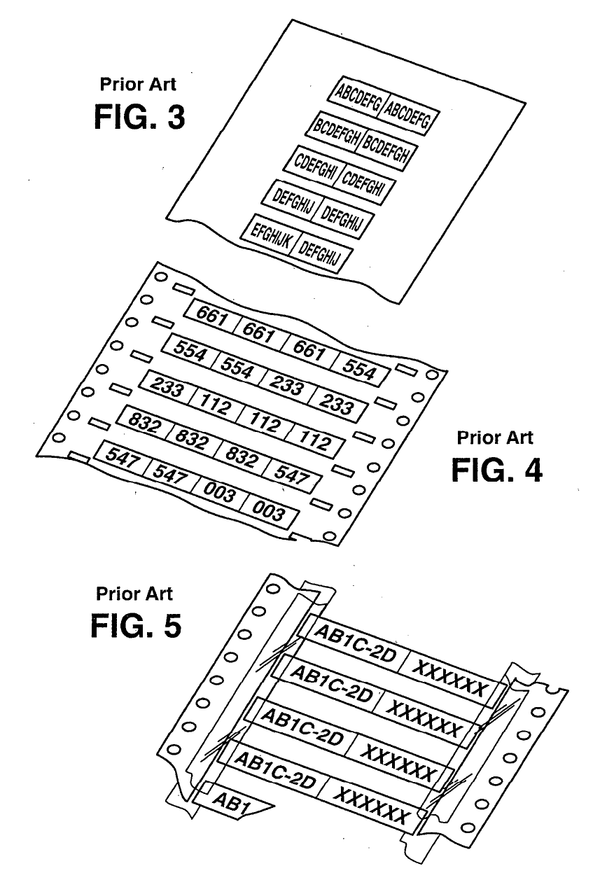

With reference to the perspective view of FIG. 2, a preferred embodiment of a system or assembly of wire identification markers generally 16 will be described. Wire identification assembly 16 is made up of a substrate 18 having a first edge 20 and a second edge 22. Substrate 18 is of some predetermined length, typically in roll form and includes a leading edge 21, a trailing edge (not shown), and opposed parallel side edges 20, 22 which extend the length of substrate 18. Substrate 18 can be made from a variety of materials including paper, fabric, nonwovens and the like. A column of markers, preferably sleeves 24 is removably attached to the substrate 18 along its length. Three columns of markers 24 are illustrated in FIG. 2 though any number of columns of markers could be employed, each including a plurality of individual wire markers 26. Further, wire identification assembly 16 does not necessarily have to include sleeve markers, but may include any other marker form suitable for identification of wires such as adhesive strips and the like.

Each column of markers 24, as illustrated in FIG. 2, includes a plurality of individual sleeves 26 positioned in abutment with adjacent sleeves. According to the present invention abutment also includes spaced apart by the width of a cutting tool used to form the individual markers. Individual sleeves 26 may be made of a printable polyolefin such as polyethylene, polypropylene, or the like, and are sized to be slipped over a wire while remaining on the wire by frictional engagement. Also, individual sleeves 26 may be made from a polymer that shrinks upon receiving heat for a snug fit around a wire. Exemplary shrinkable polymers are polyolefins and polyvinyl chloride.

Individual sleeves 26 may have indicia 27 pre-printed thereon. Alternatively, and as preferred, the individual sleeves 26 are blank and printable by a thermal transfer or other types of printers whereby a user may apply desired indicia just before use. Indicia that may be printed on the markers include numbers, letters, symbols, or the like as determined by the end user.

Each individual tubular sleeve 26 has a front opening 28 and a rear opening 30. The individual sleeves 26 are preferably positioned in columns 24 in abutting relationship such that front 28 and rear 30 openings engages the opposite opening of each adjacent sleeve 29 at engagement points 32. Individual sleeves 26, however, do not necessarily engage an adjacent sleeve but are still positioned adjacent to one another and aligned end to end to form the column 24. Individual sleeves 26 are removably attached to the substrate 18 such as by a contact adhesive applied to the substrate 18 and preferably are flat on application to the substrate. The adhesive may be applied directly to the individual markers or sleeves 26 or to the columns 24. Sleeves 26 can, however, be secured to substrate 18 by any other suitable releasable securement system.

Since printing of individual sleeves 26 is preferably done in the field, it is preferred to provide characteristics at predetermined locations along substrate 18 for sensing by printer to activate the printer at a predetermined desired location. Holes 34, notches or the like may be defined by substrate 18 along its length. In addition to physical disruptions along substrate 18, printed data, sleeve separation or the like may be provided for sensing by the printer. Holes 34 or other characteristics for printer sensing are preferably positioned in alignment with abutment points 32 along substrate 18 to cause the printer to index to the next adjacent marker and the next series of indicia. However, in other embodiments, the sensor target for printer sensing may be otherwise positioned.

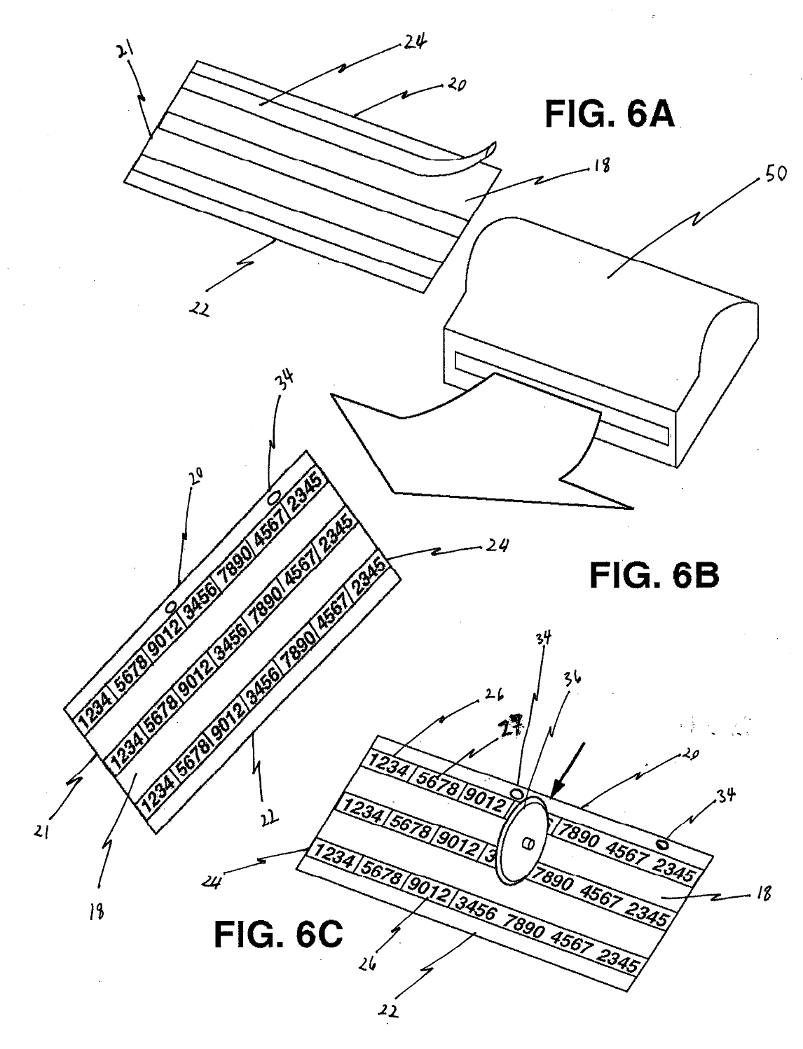

FIGS. 3 through 5 illustrate examples of the prior art. In the past, wire markers were manufactured in rows laterally across a web with a gap or space placed between rows of markers. By applying a marker lengthwise along a substrate, the present invention overcomes many disadvantages of the prior art as noted above. Specifically, less sophisticated equipment can be utilized to manufacture wire identification markers.

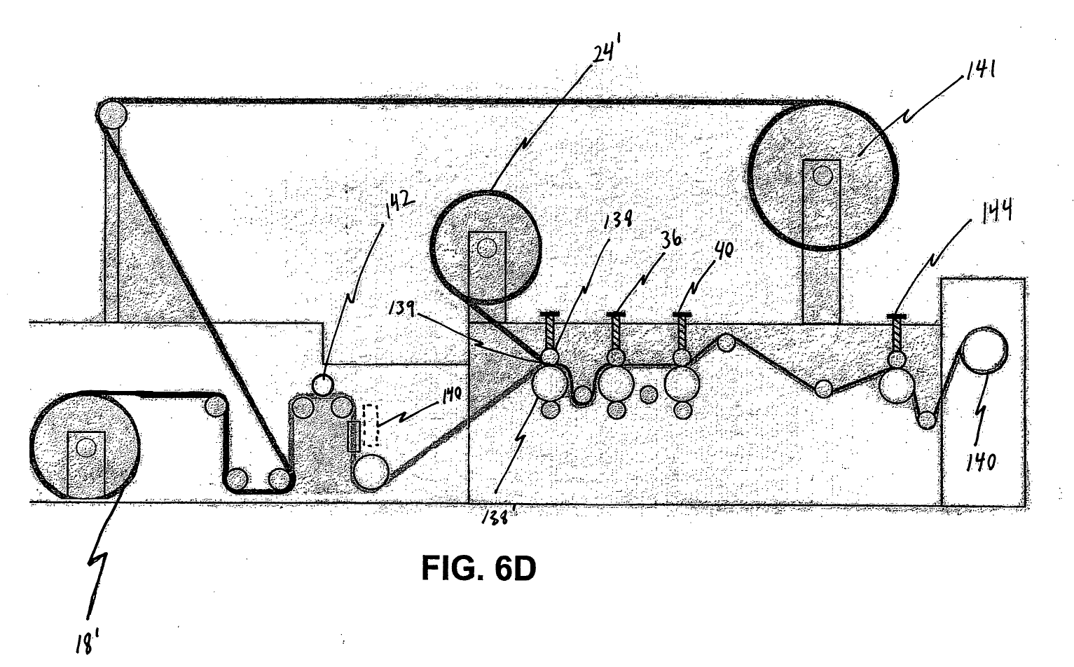

With reference to FIGS. 6A through 6D, an illustration of a preferred embodiment will be described. An elongated substrate 18, the length of which exceeds the width is provided. Substrate 18 has a leading end edge 21 and opposed side edges 20, 22. Edges 20 and 22 extend lengthwise along the substrate 18, and preferably are parallel. As illustrated in FIG. 6D, substrate 18 is preferably provided in roll form 18′ and fed through a nip 139 defined by rolls 138 and 138′. The nip roll assembly is defined by two opposing rolls that exert a predetermined pressure at the nip 139, and which may be heated if desired. The column of sleeving 24 may also be provided in roll form 24′ and fed through the nip 139 defined by rolls 138 and 138′ where sleeving 24 is removably attached, preferably by a contact adhesive, to substrate 18 by pressure from the nip roll assembly. Column of sleeving 24 is applied to substrate 18 in a manner such that it is arranged lengthwise along the substrate 18. To control lateral deviation of column of sleeving 24, a guide may be placed adjacent the nip 139 (not shown) to ensure precise placement of one or more columns onto substrate 18. The pressure at the nip can be varied depending on the type of marker material being applied to the substrate, and the rolls may be heated if desired or necessary. The roll of substrate 18′ and roll of sleeving 24′ may be supported by roll stands and in some instances the rolls may also be driven. A slitter 144 may be utilized to cut the substrate 18 to a suitable width. Substrate 18 may be provided with an adhesive coating or an adhesive applicator 140 may be utilized to apply adhesive to the column(s) of marker material 24. When substrate 18 is provided with an adhesive coating, a facesheet with liner may be provided on substrate to help prevent transfer of adhesive. The facesheet is removed prior to the attachment of sleeving 24 to the substrate 18. The facesheet waste may be collected on a waste take-up roll 141. As noted earlier, marker material column(s) 24 may be made of a polyolefin such as polyethylene or polypropylene. In a preferred embodiment, the column of sleeving 24 is made from a heat shrink polyolefin or another suitable heat shrink thermoplastic polymer such as polyvinyl chloride. The column of sleeving 24 is preferably applied flat onto substrate 18, particularly when fed from a roll. More than one column of sleeving 24 may be applied to the substrate 18 as shown in the figures. The column of sleeving 24 is cut to define individual sleeves 26. A rotary die 36 or other method known to one of ordinary skill in the art may be utilized to cut the column of sleeving 24 to define individual sleeves 26. The sleeving 24 is preferably die cut though it could also be cut by other known techniques. The individual sleeves 26 are printable or may have indicia 27 pre-printed on them. A characteristic or feature for print registration is provided on substrate 18 to allow for activation of a printer at desired intervals. In a preferred embodiment, holes, notches, or the like 34 are formed along the substrate 18 by a die cutting mechanism 40. However, other characteristics could be used so long as so long as susceptible for printer sensing. A sprayer (not shown) may be utilized to apply varnish or the like to substrate 18 to deaden or mask any remaining adhesive when substrate 18 is pre-coated with adhesive. In a preferred embodiment, an ultraviolet curing system 142 may be utilized. An ultraviolet pattern may be printed with ultraviolet ink onto substrate 18 in those areas where deactivation of the adhesive is desired. Ultraviolet curing system 142 may then be utilized to deaden or mask any adhesive in areas receiving the ultraviolet printing. The completed marker assembly may be cut to variable lengths with a cutter 144. A take-up roll 140 may be used to gather the completed marker assembly. Alternatively, the assembly may be collected as desired.

It should be appreciated by those skilled in the art that modifications and variations can be made to the exemplary embodiment of the present invention as described herein, without departing from the scope and spirit of the claims. It is intended that the invention include such modifications and variations as come within the scope of the appended claims and their equivalents.

1. An improved wire identification marker system comprising:
a substrate having a first edge and a second edge, said first edge and said second edge arranged lengthwise along said substrate;
a column of markers, said column of markers arranged lengthwise along said substrate and removably secured thereto, said column of markers configured from a plurality of individual wire markers positioned lengthwise with respect to said substrate and adjacent to one another, said plurality of individual wire markers configured from a first marker and a plurality of intermediate markers, each having a front end and a rear end, said plurality of individual wire markers positioned such that said front end of each intermediate marker is aligned with said rear end of each adjacent individual wire marker.

2. An improved wire identification marker system as defined in claim 1, further comprising a characteristic for printer sensing along said substrate.

3. An improved wire identification marker system as defined in claim 1, wherein more than one said column of markers is located on said substrate.

4. An improved wire identification marker system as defined in claim 1, wherein said plurality of individual wire markers are removably adhesively attached to said substrate and are in abutting relationship with each next adjacent individual wire marker.

5. An improved wire identification marker system as defined in claim 1, wherein said plurality of individual wire markers are manufactured from a polyolefin.

6. A set of wire identification sleeves comprising:
a substrate having a first edge and a second edge, said first edge and said second edge arranged lengthwise along said substrate;
a column of sleeves, said column of sleeves arranged lengthwise along said substrate and removably secured thereto, said column of sleeves configured from a plurality of individual sleeves positioned lengthwise and adjacent to one another, said plurality of individual sleeves configured from a first sleeve and a plurality of intermediate sleeves, each having a front opening and a rear opening, said plurality of individual sleeves positioned such that said front opening of each intermediate sleeve is aligned with the said rear opening of each adjacent individual sleeve; and
a characteristic for printer sensing positioned along said substrate.

7. A set of wire identification sleeves as defined in claim 6, wherein more than one said column of sleeves is located on said substrate.

8. A set of wire identification sleeves as defined in claim 6, wherein said plurality of individual sleeves are in abutting relationship with each next adjacent individual sleeve and said plurality of individual sleeves are printable.

9. A set of wire identification sleeves as defined in claim 6, wherein said plurality of sleeves is removably attached with an adhesive to said substrate.

10. A set of wire identification sleeves as defined in claim 6, wherein said plurality of sleeves are manufactured from a polyolefin.

11. A process for forming a wire identification marker system comprising the steps of:
providing a continuous length of substrate with an adhesive coating and feeding said substrate along an intended path;
providing a continuous length of wire marker material and feeding said wire marker material along said intended path into contact with said substrate at a predetermined position on said substrate;
removably securing said wire marker material to said substrate; and
cutting said wire marker material to define a plurality of individual wire markers.

12. A process as defined in claim 11, wherein said substrate is manufactured from paper.

13. A process as defined in claim 11, further comprising the step of forming a characteristic for print registration on said substrate.

14. A process as defined in claim 11, wherein said wire marker material is manufactured from a polyolefin.

15. A process as defined in claim 11, wherein said wire marker material is receptive to printing.

16. A process for forming a set of identification sleeves comprising the steps of:
providing a continuous length substrate coated with adhesive and feeding said substrate through nip rolls;
providing a continuous length marker printable tubing and feeding said tubing through said nip rolls onto the top of said substrate at a predetermined location thereon, roll pressure forcing said tubing against said substrate and into said adhesive coating for removable securement thereto;
cutting a portion of said substrate at predetermined locations along its length to define characteristics for print registration; and
cutting said tubing to define a plurality of individual marker sleeves.

17. A process as defined in claim 16, further comprising the step of spraying said substrate after securement of said tubing thereto in areas where tubing is not secured with a composition to deactivate or mask the exposed adhesive.

18. A process as defined in claim 16, wherein said substrate is manufactured from paper.

19. A process as defined in claim 16, wherein said tubing is manufactured from a polyolefin.

20. A process as defined in claim 16, further comprising the step of printing an ultraviolet pattern onto said substrate after securement of said tubing thereto in areas where tubing is not secured and curing said ultraviolet pattern to deactivate or mask the exposed adhesive.
